(19) United States
(12) Patent Application Publication
(10) Pub. No.: US 2003/0233549 A1
(43) Pub. Date: Dec. 18, 2003

(54) File exchange apparatus, personal information entry/introduction server, transmission controlling method, and program therefor

(75) Inventors: Takahisa Hatakeyama, Kawasaki (JP); Hidefumi Maruyama, Kawasaki (JP); Tetsuhiro Chiba, Kawasaki (JP); Takayuki Hasebe, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/463,006

(22) Filed: Jun. 16, 2003

(30) Foreign Application Priority Data
Jun. 17, 2002 (JP) 2002-175888

(51) Int. Cl. H04L 9/00

(52) U.S. Cl. 713/170; 713/176; 713/156

(57) ABSTRACT

A user terminal has a file exchanging capability provided with a transmission control unit, a reception control unit, and an entry unit. As the transmitting capability by the transmission control unit, the entry unit makes an entry in an external specific server. Unless a digital certificate can be obtained for an individual public key through the server, contents is unavailable. When contents are transmitted or enabled for transmission, the transmission control unit assumes that a signature has been placed without fail. The reception control unit checks the signature of the received contents, and controls the contents to be unavailable unless a correct signature has been placed.

### BACKGROUND OF THE INVENTION

1. Field of the Invention

The present invention relates to an apparatus, a method, and a storage medium for exchanging files, avoiding the possibility of a user violating copyright protection, suppressing an act of illegal copying, and allowing a user to positively use the apparatus, method and storage medium including a contents holder.

2. Description of the Related Art

Recently, a service called a “file exchange application” has become popular. However, the service using the “file exchange application” has problems of the copyright protection violations described below.

(1) A “file exchange application” service provider has lost a lawsuit relating to copyright protection, and has been reconstructed such that it cannot distribute major pieces of music. Therefore, general users cannot exchange hits using the application, the popularity of the application has plunged at least in the U.S., and the number of users has considerably decreased.

(2) Since a “file exchange application” service provider has no specific introduction services or specific applications for large-volume users, the propagation speed is low, but there are no specific target to be accused. therefore, the copyright protection violations remain uncontrolled in the U.S.

(3) In Japan, a high premium is placed on the Copyright Act unlike in the U.S and Europe. Therefore, a user commits a crime only by placing contents without a right on a server which can transmit contents to a number of unspecified general clients

On the other hand, various types of DRM (digital rights management) have become pupularized as copyright protection technology, but the problems of illegal copying of the file exchange applications include the problems of analog information illegal copying. Therefore, the access restrictions by the conventional DRM (digital rights management) cannot successfully avoid these problems. As a result, the illegal distribution of analog copies (contents once represented by analog data and then copied in the digital representation) cannot be suppressed. Furthermore, in the technology of detecting illegal access using electronic watermark, an illegal act can be detected after an analog copy is illegally distributed, but it cannot be suppressed in advance.

Furthermore, a system of controlling a transmission has been adopted by filtering illegally copied contents using a contents name, etc. However, an application for avoiding the transmission control by falsifying a contents name has been developed.

Under the above-mentioned situation, there are the following requests.

Contents holders have issued a request for the function of preventing illegal remote copying of contents by a file exchange application.

Especially in Japan, for fear that a user can mistakenly commit a crime without knowing the possibility described in (3) above, general users latently request a “convenient file exchange application for automatically preventing the above-mentioned crime”.

Furthermore, users themselves may generate original contents. There also are requests to distribute and sell these contents of the users.

### SUMMARY OF THE INVENTION

The present invention has been developed to solve the above-mentioned problems, and aims at providing a file exchange apparatus, a personal information entry/introduction server, a transmission controlling method, and a program therefor capable of avoiding the possibility of a user of a file exchange application violating copyright protection, preventing illegal remote copying of contents, thereby promoting the distribution by a contents holder, etc. to a file exchange application, and supporting distribution and sales of contents of users themselves.

The present invention is configured to include a transmission control unit, in a file exchange apparatus of a user terminal having a file exchanging capability among user terminals, for encrypting a plaintext file, generating a license, placing a digital signature using a secret key on the encrypted or the license, adding a digital signature using the secret key to the file or the license is there is no digital signature, and storing the signature in a transmit enabled area.

The above-mentioned plaintext file may be the above-mentioned illegal analog copy (contents once represented by analog data and then copied in digital data), or others (generated by a user).

Using the file exchange apparatus with the above-mentioned configuration, since a transmit enabled file is signed, a user who intentionally makes an illegal analog copy can be detected by the signature as a source of the illegal act, thereby suppressing the illegal act. For non-malicious users, signatures guarantee them the originality of the contents, and are welcomed by the request to assert the correct copyrights of the users.

Furthermore, for example, the transmission control unit can be configured such that, if there is no signature on an encrypted file when a secondary transmission is performed, the secondary transmission is not enabled or a signature of a user who performs a secondary transmission is forcibly added after displaying a warning.

If there is no signature, the secondary transmission is not enabled or the warning is displayed, thereby preventing a non-malicious general user from mistakenly raising a copyright protection violation problem. If a transmission request or a transmit enabling request is issued even after the warning is displayed, the signature of the user who performs a secondary transmission is forcibly added. In this case, the user can be informed that the signature of the user who performs a secondary transmission is added. This, as described above, suppresses a user who intentionally make an illegal remote copy.

Furthermore, the present invention can include a reception control unit for preventing the contents of a file from being used if there is no signature on a received file, or if it is determined that the signature on the received and signed file is correct.

The file exchange apparatus according to the present invention can be configured to include a transmitting/receiving capability or a receiving capability only.

Relating to the receiving capability, the reception control unit controls the contents of a received file not to be used without a correct signature. Therefore, if the signature of signed contents transmitted by a transmitter is deleted during the transmission, or the contents are transmitted from a device other than a device for transmission control according to the present invention, then the contents cannot be used after all.

Furthermore, for example. the present invention can include an entry unit for transmitting an entry request including user personal information about the file exchange apparatus and a public key in a public key encryption system to an external personal information entry/introduction server, and receiving a certificate issued by an Certification Authority through the personal information entry/introduction server in response to the entry request, and the transmission control unit can be used when the entry unit makes an entry.

Thus, when a transmitting capability of the file exchange apparatus is available, the user personal information, etc. is to be forcibly entered in a specific server, thereby easily specifying an offender and furthermore successfully suppressing an illegal act. The thus obtained certificate can be evaluated as a certificate with higher reliability.

Additionally, for example, the transmission control unit or the reception control unit is configured as a tamper resistant module, and the tamper resistant module has DRM (digital right management), and the transmit enabled area is an area which cannot be rewritten by nothing other than the DRM.

Thus, a file without a signature cannot be place in a transmit enabled area without permission in any method.

Using the file exchange apparatus according to the present invention, the contents holder can rely upon the file exchange application, and a major contents holder can promote the distribution of contents to a file exchange application.

Furthermore, the personal information entry/introduction server according to the present invention includes a personalization unit for entering the personal information each time an entry request including user personal information and a public key is received from the file exchange apparatus, requesting an Certification Authority to issue a certificate corresponding the public key, and transferring the issued certificate to the file exchange apparatus.

The personal information entry/introduction server can include a user contents introduction unit for entering a contents file each time the file exchange apparatus of the entered user issues an entry request of any contents file, and introducing an entered contents file to any file exchange apparatus.

Using the personal information entry/introduction server with the above-mentioned configuration, users having the transmitting capability of the file exchange apparatus are centrally managed, and an offender can be easily and correctly specified, thereby efficiently suppressing the illegal act. Furthermore, a service of distributing and selling the contents of a transmitting capability user can be provided.

The above-mentioned problems can also be solved by reading a program by a computer from a computer-readable storage medium storing the program used to direct the computer to perform the control similar to the control with each of the above-mentioned configurations of the present invention.

### BRIEF DESCRIPTION OF THE DRAWINGS

FIG. 1 is a block diagram showing the functions of the user terminal with the file exchanging capability according to an embodiment of the present invention;

FIG. 2 is an explanatory view of the file exchanging process performed using the file exchange application according to an embodiment of the present invention;

FIG. 3 is a flowchart of the entire process performed by the file exchange apparatus of a transmitter;

FIG. 4 is a detailed flowchart of the contents transmit enabling process shown in FIG. 3;

FIG. 5 is a detailed flowchart of the contents transmitting process shown in FIG. 3;

FIG. 6 is an explanatory flowchart of the process procedure of the file exchange apparatus (DRM) of a contents receiver;

FIG. 7A shows Sender entry request information, FIG. 7B shows contents entry request information, and FIG. 7C shows an example of access condition information;

FIG. 8 shows an example of a business model using the file exchange apparatus according to an embodiment of the present invention;

FIG. 9 shows the configuration of the network system corresponding to the business model shown in FIG. 8;

FIG. 10 shows an example of a hardware configuration of a computer; and

FIG. 11 shows an example of a storage medium storing a program or downloading a program.

### DESCRIPTION OF THE PREFERRED EMBODIMENT

The embodiments of the present invention are described below by referring to the attached drawings.

In the explanation of the following embodiments, the encryption algorithm for encryption of contents, licenses, etc. is not specified.

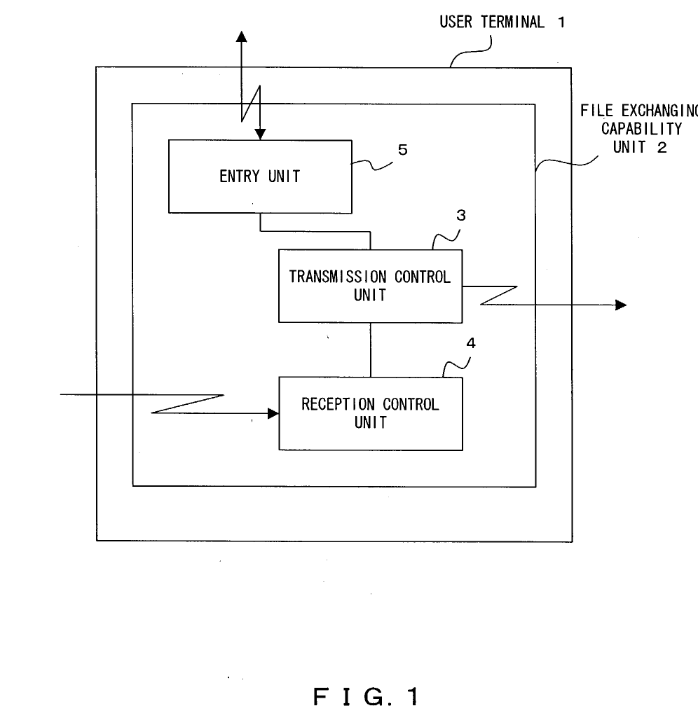

FIG. 1 is a block diagram of the function of the user terminal having the file exchanging capability according to an embodiment of the present invention.

A user terminal 1 can be, for example, a mobile phone, a PHS, other PDA (personal digital assistants), a personal computer, etc. The user terminal 1 comprises a file exchanging capability unit 2. The file exchanging capability unit 2 is realized by, for example, a file exchange application. The file exchanging capability unit 2 comprises a transmission control unit 3, a reception control unit 4, and an entry unit 5, but does not have to comprise all of them. For example, it may comprise only the reception control unit 4 (receive-only unit). The user terminal 1 can also comprise a communications control capability, any information processing capability, etc. which are not shown in the attached drawings or described in detail.

The transmission control unit 3 controls, for example, the contents especially in remotely transferring (including moving) a license in addition to the function of the suggested (described below in detail) UDAC, and has the function of forcing an application user to perform the control. The contents refers to digital contents of, for example, music, document text, images, moving pictures, program software, etc. In the following explanation, a digital certificate and a digital signature can also be referred to simply as a certificate and a signature respectively.

The entry unit 5 enters the information about the user terminal 1 and its users in an external specific server (not shown in the attached drawings ; personal information entry server, etc.), and requests an Certification Authority to issue a digital certificate corresponding to a public key secretly generated in the file exchanging capability unit 2 through the server. Upon receipt of a digital certificate after the entry in the entry unit 5, the function of the transmission control unit 3 is available.

The transmission control unit 3 forcibly places a signature using a secret key in the public key encryption system when contents are to be transmit enabled. When a transmission request is issued from the reception control unit 4 of another user terminal 1, the signed contents are transmitted together with the digital certificate. By forcibly placing a signature, the source of the contents can be clarified (as to who has transmitted the contents). Especially, unless a user is entered as a user in the above-mentioned specific server, the user cannot use a transmitting capability. Therefore, for example, a user trying to intentionally make an illegal copy is suppressed.

When the reception control unit 4 requests the transmission control unit 3 of another user terminal 1 to transmit contents, and receives the requested contents from the user terminal 1 (transmitter), it checks whether or not the signature is correct using the digital certificate. If it is not correct, the contents is disabled (for example, rejects the reception, record, regeneration, etc.). Since the digital certificate is issued through the above-mentioned specific server after a user entry in the server, it is evaluated as a certificate with high reliability.

The above-mentioned UDAC (universal Distribution with access control) is a security basic technology already presented by the present applicant with the super-distribution of contents including music, etc. taken into account. The technology is introduced in, for example, the following reference documents 1, 2, etc.

Reference Document 1: “Open Super-Distribution Infrastructure Realizing the Tenacity of the Content Protection”, Information Processing Society of Japan, Report of Computerized Intellectual Property/Social Basic Institute, November, 2001, by Takeaki Anazawa, Koji Takemura, Takashi Tsunehiro, Takayuki Hasebe, and Takahisa Hatakeyama: http://www.keitaide-music.org/pdf/EIP14-5.pdf

Reference Document 2: “Super-Distribution and Security of Music Contents”, FUJITSU, Vol. 52, No. 5, p.473-481, September, 2001, Takahisa Hatakeyama, Hidefumi Maruyama, Tetsuo Chiba: http://magazine.fujitru.com/

As described in the above-mentioned reference documents 1 and 2, the UDAC-MB (media base) which is one of the UDAC technologies aims at mutially operating the system when contents are distributed, moved, and regenerated online, and the technology of forcibly performing remote access control of contents. Additionally, the present applicant and others have conventionally suggested the equipment and software for realizing the movement, decoding, and regeneration of contents as a TRM (tamper resistant module) as security means especially by introducing the DRM (digital rights management) and presenting the and software for realizing the DRM as a TRM (these equipment and software are hereinafter referred to simply as DRM). As a countermeasure suggested against a pretender, DRM authentication is performed in transferring a license so that a session key (temporary encryption key) can be secretly shared between the DRM of the license source and the authenticated destination DRM, and the license is encrypted using the session key and transferred to the destination DRM so that the security can be guaranteed. The DRM authentication is a one-way authentication for authentication of license destination DRM only. Relating to the above-mentioned UDAC-MB, a number of patent applications have been files by the present applicant (for example, Japanese Patent Application Laid-open No. Hei-05-257816, Japanese Patent Application Laid-open No. Hei-08-101867, Japanese Patent Application Laid-open No. Hei-08-106382, Japanese Patent Application Laid-open No. Hei-08-190529, Japanese Patent Application Laid-open No. 2000-293439, Japanese Patent Application Laid-open No. Hei-05-257816, Japanese Patent Application Laid-open No. Hei-08-101867, Japanese Patent Application Laid-open No. Hei-08-106382, etc.).

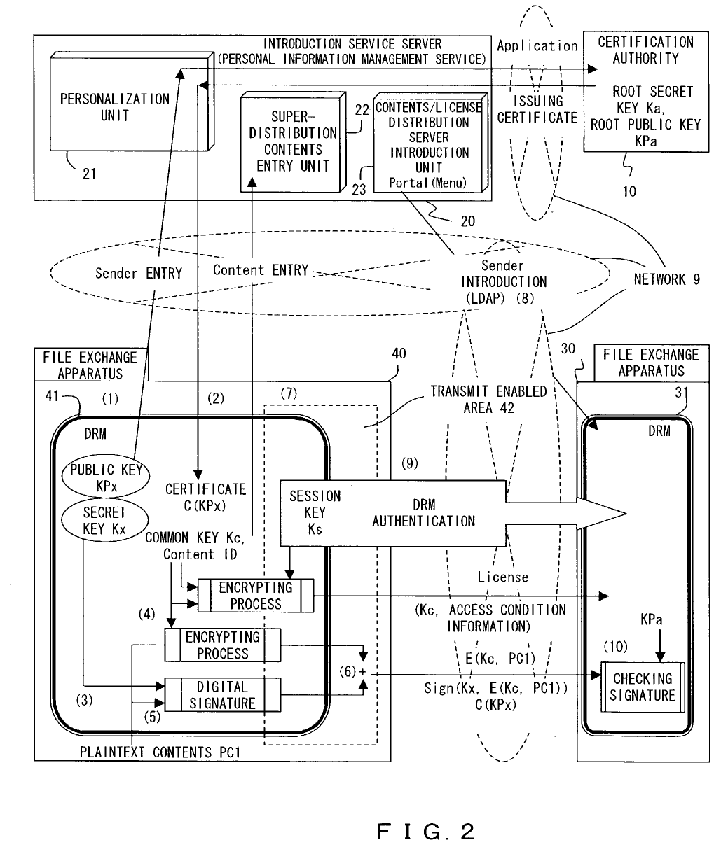

FIG. 2 is an explanatory view of the file exchanging process performed using the file exchange application according to an embodiment of the present invention.

In FIG. 2, an Certification Authority 10 is a server of a system for issuing a public key certificate (C(KPx)) for checking a digital signature of a contents transmitter, and has a pair of a root public key (KPa) and a root secret key (Ka) for a signature to be placed on a certificate. The Certification Authority 10 cannot be an Certification Authority of the UDAC, but can be an Certification Authority of a common electronic transaction.

An introduction service server (personal information entry server) 20 generally comprises a personalization unit 21, a super-distribution contents entry unit 22, and a contents/license distribution server introduction unit 23. Furthermore, like the introduction of the conventional contents distribution server, the introduction service of the user terminal 1 (excluding a receive-only terminal) can be provided.

The personalization unit 21 enters transmitter DRM (entry of a transmitter) described later, performs a certificate issue intermediating process, etc.

The super-distribution contents entry unit 22 receives encrypted contents and/or license and an entry of the address of the transmitter DRM for distributing the encrypted contents and/or license, and maintains the information in a directory database (not shown in the attached drawings).

When an introduction request is received from a receiver file exchange apparatus 30, the contents/license distribution server introduction unit 23 displays a portal menu (a list of the information relating to the entered contents) and introduces the contents.

The introduction service server 20 not only performs a process of entering transmitter DRM (entry of a transmitter), a certificate proxy issue process, etc., but also, for example, has the function of introducing a server for distributing contents and a license suggested by the present applicant in Japanese Patent Application No. Hei 13-272638, and can also introduce a transmitter DRM. That is, the entered transmitter DRM is a type of distribution server. Using the suggested function of a server, for example, the personalization unit 21 can further perform a user information association process, etc. with an advertisement model. Additionally, a content ID can be specified by receiver DRM to have the address of a distribution server of encrypted contents and/or license introduced, and can also be specified by selecting an interactive menu including a list of contents on sale transmitted from the receiver DRM.

In FIG. 2, the receiver file exchange apparatuses 30 and 40 correspond to the file exchanging capability unit 2 shown in FIG. 1.

The receiver file exchange apparatuses 30 and 40 have DRM 31 and 41 respectively. The DRM 31 and 41 are realized as the TRM as described above, and perform the transmission/reception control according to the present embodiment in the DRM 31 and 41. The DRM is described above by referring to the reference documents 1 and 2, and is not explained here in detail, but is realized by software.

The receiver file exchange apparatuses 30 and 40 can have the same functions (transmitting/receiving capabilities), or the receiver file exchange apparatus 30 of the receiver can be a receive-only device (by independently preparing a receive-only file exchange apparatus (file exchange application), or using a device simply in a transmit disabled state (a device which has not yet been entered in the introduction service server 20) can be referred to as a receive-only device). In the following explanation, “transmission” includes enabling for transmission.

In FIG. 2, the receiver file exchange apparatus 30 is a receiver and the file exchange apparatus 40 is a transmitter. As described above, for example, the contents transmitted by the file exchange apparatus 40 may have been received from another file exchange apparatus and are to be retransmitted (secondary transmission), or the receiver file exchange apparatus 30 of the receiver may retransmit (secondary transmission) the received contents. However, in the explanation shown in FIG. 2, since the receiver file exchange apparatus 30 is a receiver, and the file exchange apparatus 40 is a transmitter, the file exchange apparatus 40 has the transmitting capability and the receiver file exchange apparatus 30 has the receiving capability in the following explanation and drawings. The DRM 41 of the file exchange apparatus 40 can be hereinafter referred to as a transmitter DRM 41, and the DRM 31 of the receiver file exchange apparatus 30 as a receiver DRM 31.

The outline of each function of the transmitter DRM 41 and the receiver DRM 31 is described below.

The transmitter DRM 41 transmission controls the contents to be transmitted with a signature placed on them. For example, when plaintext contents generated by a user are transmitted or enabled for transmission, for example, the plaintext contents are encrypted, and the encrypted contents is signed using a secret key in the public key encryption system. Although the contents may not be encrypted an instruction of a user, the plaintext contents is to be signed.

Furthermore, although the contents are not plaintext generated by the user, and are encrypted contents copied or moved from another file exchange apparatus, correctly signed contents can be enabled for transmission (can be transmitted as a secondary transmission). Without a signature, a warning is issued to forcibly add a signature for transmission (enabling for transmission). However, when a request to transmit encrypted contents without a signature is issued, a strong message is issued to inform that there is a possibility of violating a copyright protection. For example, a message warning, “If these contents are not admitted by all related copyrighters as your production or enabling for transmission, you are violating the Copyright Act, and can be punished. Accepted?” can be displayed. If the user specifies enabling for transmission even after displaying the message, a signature is forcibly added for enabling for transmission.

Furthermore, if an entry is not made in the introduction service server 20, the transmitter DRM 41 cannot transmit (enable transmission) contents. However, contents can be received (download/streaming) even in a no-entry state.

Described roughly below are the functions of the receiver DRM 31.

Each of the receiver DRM 31 and 41 holds a root public key (KPa) of the Certification Authority 10 for checking a signature.

Upon receipt of the contents from the transmitter DRM 41, and if the contents are not signed, or if it is determined that a signature is not correct as a check result, then the receiver DRM 31 practically disables the contents (for example, by forcibly rejecting environment, record, regeneration, etc. of the contents).

If the certificate of a transmitter becomes invalid by an issue of a CRL from the Certification Authority 10 or the expiration date of the certificate, etc. that is, if contents have been received with a signature using a secret key corresponding to an invalid certificate, then the contents are forcibly deleted. The CRL issued in haste cannot be transmitted until the receiver accesses the introduction service server 20.

The receiver DRM 31 can have a distribution server (not only the conventional contents distribution provider but also a file exchange apparatus which has made an entry as described above) of encrypted contents and licenses introduced using the introduction service server 20. In this case, an LDAP (lightweight directory access protocol) is used.

The above-mentioned transmission/reception control is forcibly realized by, for example, in the following procedure (indicated by (1) through (10) shown in FIG. 2).

In this example, it is assumed that the file exchange apparatus 40 has not made an entry in the introduction service server 20, and the explanation of the processes up to the entry process is given below.

(1) First, if a user requests to set his or her file exchange apparatus in a state in which contents transmitting capability is available, the user issues a predetermined entry instruction. In response to the instruction, the file exchange apparatus 40 issues an entry request message for the transmitter DRM 41 of the apparatus to the personalization unit 21 of the introduction service server 20 through the network 9. The entry request message includes a public key (KPx) in a pair of a public key (KPx) and a secret key (Kx) secretly generated in the transmitter DRM 41. It further includes user personal information.

(2) The personalization unit 21 of the introduction service server 20 checks whether or not the entry request information (including personal information) about the transmitter DRM 41 transmitted from the file exchange apparatus 40 is deficient. If it is not deficient, the public key (KPx) to be entered is transmitted through the network 9, and a certificate (C(KPx)) is issued.

That is, in the CA (Certification Authority), a digital signature is placed using a root secret key Ka of the CA (Certification Authority) corresponding to the public key (KPx), and a certificate (C(KPx)) of the public key (KPx) is generated.

The certificate (C(KPx)) is transmitted as a result of the completion of entry from the introduction service server 20 to the transmitter DRM 41 through the network 9. Upon receipt of the certificate (C(KPx)), the transmitter DRM 41 enters a transmit enabled state. Additionally, for example, the DRM of each file exchange apparatus is initially not provided with a transmitting capability. Therefore, the file exchange apparatus can be provided with a transmitting capability by a plug-in of a transmitting capability module received from the introduction service server 20 to the DRM after the completion of the entry.

(3) After acquiring the certificate (C(KPx)), the transmitter DRM 41 performs the following contents transmit enabling process at each contents transmit enable request. In FIG. 2, as already described above, for example, the plaintext contents generated by the user are specified in a transmit enable request.

(4) First, the plaintext contents PC1 specified in the transmit enable request is encrypted (the encrypted contents “E(Kc, PC1)” are generated) using the common key Kc (contents encryption key) secretly generated in the transmitter DRM 41.

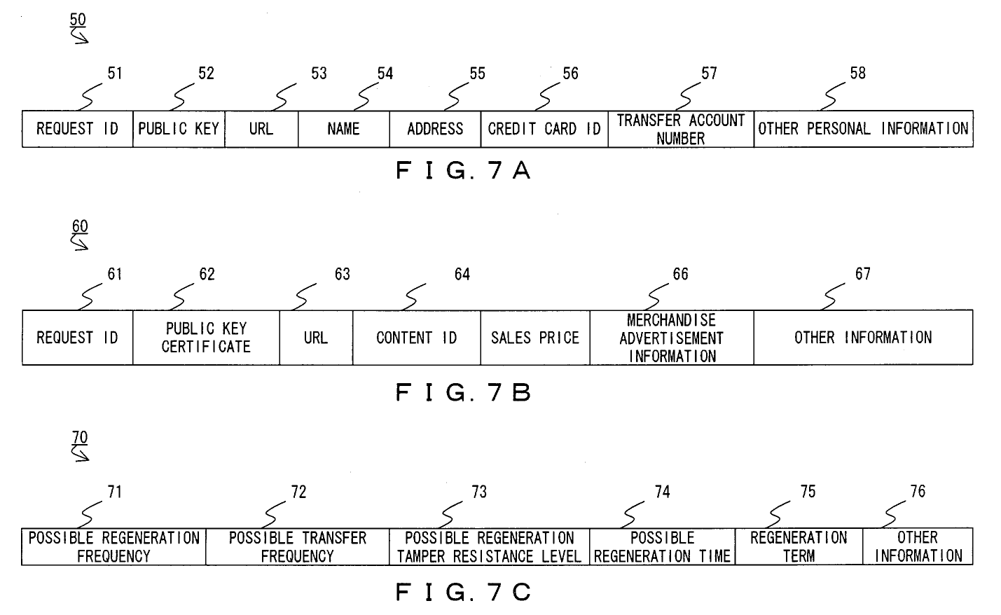

Furthermore, the common key Kc and the access condition information are encrypted using the session key Ks, and a license (Kc, access condition information) is generated. About the access condition information, an example is shown in FIG. 7(c), and described later. The encryption can be performed using the session key Ks after coupling the common key Kc to the content ID. A session key Ks refers to a secret key shared with a receiver file exchange apparatus through the above-mentioned DRM authentication. The encryption can also be performed using not only the session key Ks but also, for display, the receiver public key.

(5) Next, the digital signature “Sign (Kx, E(Kc, PC1)” of the encrypted contents is generated using the secret key Kx generated in (1) above.

(6) Then, the signed encrypted contents “E(Kc, PC1)+Sign (Kx, E(Kc, PC1))” obtained by adding the digital signature to the encrypted contents are stored in the transmit enabled area 42 in the file exchange apparatus 40 (of the transmitter). The transmit enabled area 42 is described later in detail, but can be simply described as follows. That is, when contents not stored in the transmit enabled area are requested, the request is rejected.

(7) Then, a request to enter the plaintext contents PC1 specified in the above-mentioned transmit enable request is transmitted with the information such as the identification number (content ID) assigned to the plaintext contents PC1, the URL of the user, the information about the contents, etc. to the super-distribution contents entry unit 22 of the introduction service server 20 for entry. (The introduction service provider can use the encrypted contents/license distribution service.)

(8) When a user inputs a request to, for example, obtain contents, the receiver file exchange apparatus 30 (of the receiver) can access the contents/license distribution server introduction unit 23 at any time, and browse the above-mentioned portal menu.

When the user of the receiver file exchange apparatus 30 (of the receiver) requests to obtain, browse, or purchase desired contents by referring to a list (portal menu) of the contents of the entered file exchange apparatus 40 (of the transmitter), the user selects the contents on the menu. The contents/license distribution server introduction unit 23 transmits the content ID of the selected contents and the address (URL, etc.) of the file exchange apparatus 40 in which the contents have been entered to the receiver file exchange apparatus 30.

(9) The receiver file exchange apparatus 30 (of the receiver) accesses the address obtained from the contents/license distribution server introduction unit 23, and requests the contents of the obtained content ID.

At the request, the file exchange apparatus 40 (of the transmitter) transmits the signed encrypted contents “E(Kc, PC1)+Sign (Kx, E(Kc, PC1))” of the requested contents together with the certificate (C(KPx)) to the receiver file exchange apparatus 30 (of the receiver) which is the requester.

At this time, a license (Kc, access condition information) can be transmitted, or the license (Kc, access condition information) can be independently transmitted (for example, after the receiver file exchange apparatus 30 (of the receiver) normally completes a signature check as described later, or when the procedure of purchasing contents is independently performed, etc. When a license is transferred, the DRM is authenticated in the UDAC-MB system already suggested by the present applicant, etc.

(10) Upon receipt of the signed encrypted contents “E(Kc, PC1)+Sign (Kx, E(Kc, PC1))”, the receiver file exchange apparatus 30 (of the receiver) checks the certificate (C(KPx)) and the signature (Sign(Kx, E(Kc, PC1))) using the root public key KPa, and enables the contents if they are correct (the signature is correct).

As described above, the contents correctly processed up to (10) above can be regenerated at any time in the receiver file exchange apparatus 30 (of the receiver).

The above-mentioned process procedure is only an example, and the appropriate procedure is not limited thereto. For example, the file exchange apparatus 40 (transmitter) can place the signature on the license, and the receiver file exchange apparatus 30 (of the receiver) can check the signature of the license. In this case, the processing time can be shortened.

Although not shown in the attached drawings, the certificate (C(KPx)), public key (KPx), secret key (Kx), common key Kc, etc. are stored in a predetermined storage area in the DRM.

By issuing the CRL (certificate revocation list) by the CA, etc., a new certificate can be issued when a transmitter entry or a contents entry is first made after the expiration date of the DRM certificate of the transmitter.

Furthermore, the file exchange apparatuses (DRM) can mutually perform introduction without the introduction service server 20. This function can be realized by, for example, SOAP (Simple Object Access Protocol) and UDDI (Universal Description, Discovery and Integration).

The explanation by referring to FIG. 2 is given by describing the case in which plaintext contents are enabled for transmission, but can also be realized by, for example, a secondary transmission.

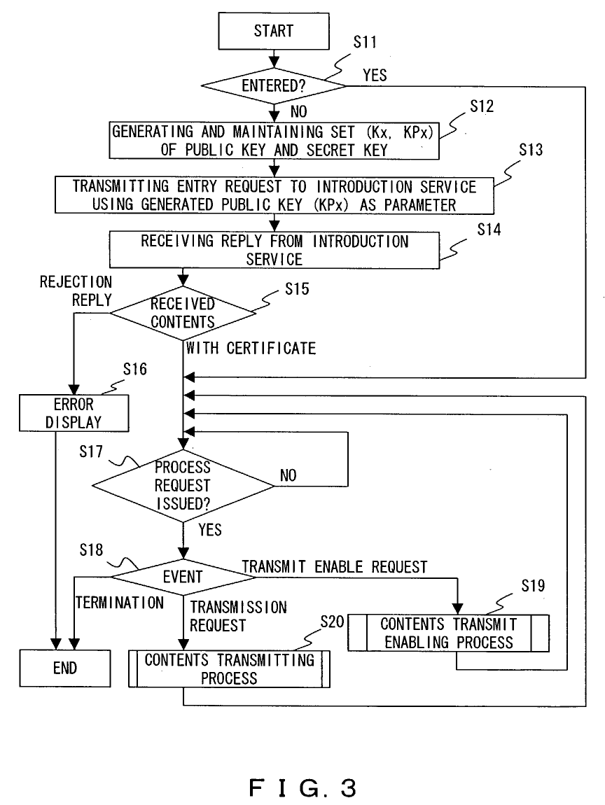

The entire transmitting process of DRM is described below by referring to FIGS. 3 through 5.

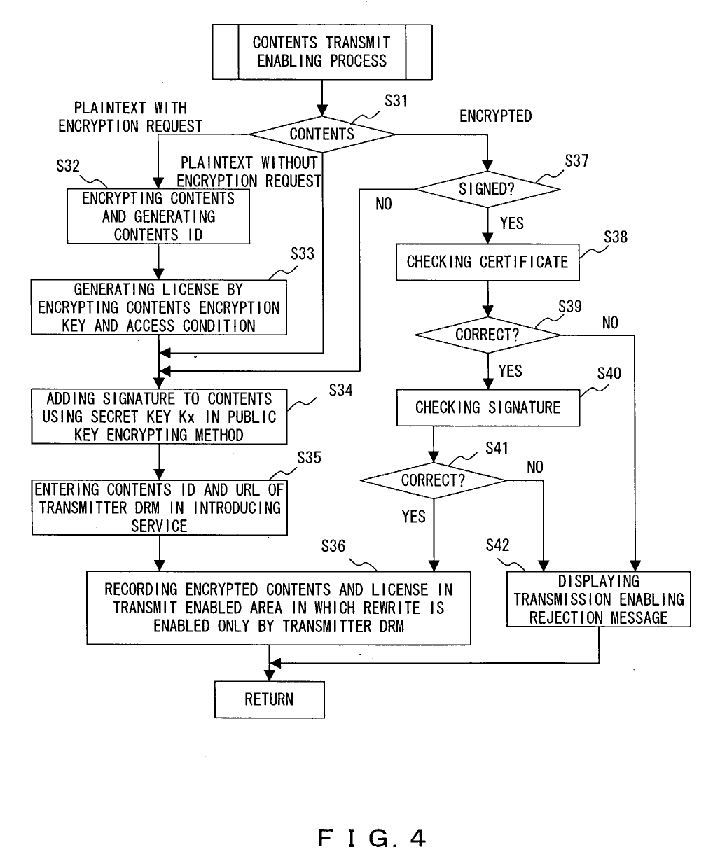

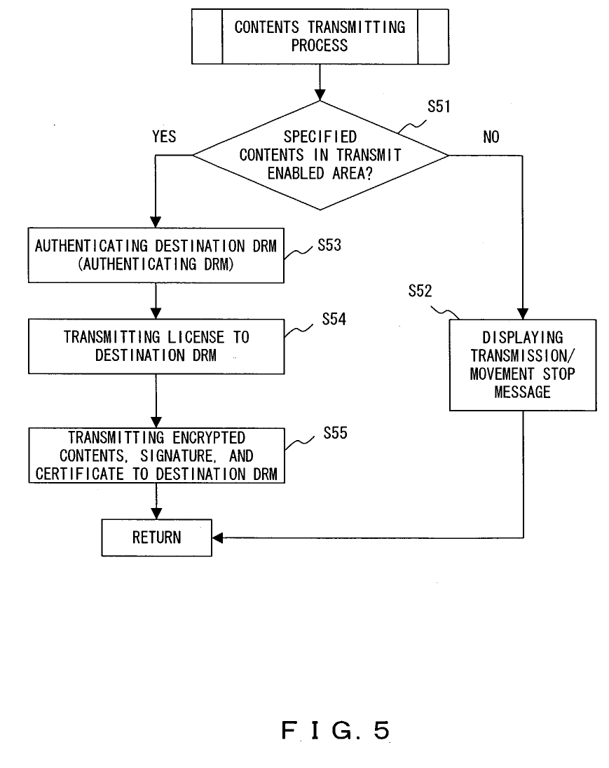

FIG. 3 is a flowchart of the entire process of the transmitter. FIG. 4 is a flowchart of the details of the contents transmit enabling process. FIG. 5 is a flowchart of the contents transmitting process.

First, refer to FIG. 3.

When the user requests contents to be enabled for transmission, the file exchange apparatus 40 determines whether or not it has been entered (step S11). If it has not been entered (NO in step S11), then it issues an entry request of the transmitter DRM 41 to the introduction service server 20. That is, the file exchange apparatus 40 secretly generates a pair of a public key (KPx) and a secret key (Kx), holds them (step S12), and transmits the entry request using the generated public key (KPx) as a parameter to the introduction service server 20 (step S13). (process of (1) above) In response to the request, the introduction service server performs the process of (2) above, and returns a process result. Upon receipt of the process result (step S14), the received contents are checked (step S15). If it is an entry rejection reply, an error display is performed (step S16), thereby terminating the process. If it has not been entered, the file exchange apparatus 40 cannot distribute the contents (but can be used as a receive-only device).

On the other hand, if an entry is normally made and a certificate (C(KPx)) issued by the CA (Certification Authority) is returned, then the file exchange apparatus 40 enters a transmit enabled state. Afterwards, each time any request relating to a contents transmission is issued (YES in step S17), the contents transmit enabling process (step S19) and the contents transmitting process (step S20) are performed depending on the request (step S18). When a termination request is issued, the process terminates.

Relating to the contents transmit enabling process (step S19) and the contents transmitting process, the detailed process flowcharts are shown in FIGS. 4 and 5.

First, the contents transmit enabling process is described below in detail by referring to FIG. 4.

In FIG. 4, if any contents transmit enable request is issued, it is determined whether the contents have already been encrypted or plaintext contents (furthermore whether or not there is an encryption request) (step S31), and the corresponding process is performed depending on the determination result. Whether the plaintext contents is to be transmitted or encrypted, the user optionally specified.

First, the case in which a request to encrypt plaintext contents is described below.

The plaintext contents can be originally generated by the user, or can relate to the problem of an analog copy illegal distribution (That is, the contents once represented as analog data, and then copied as digital data). The file exchange apparatus according to the present embodiment is not to detect such an illegal copy, but to detect the source by forcibly placing a signature, thereby successfully suppressing the user from an illegal act.

On the other hand, if the plaintext contents are originally generated by the user, then the signature guarantees the originality of the contents, and can be used in asserting the copyright of the user.

If it is determined that the contents are plaintext contents in step S31, then the plaintext contents are first encrypted using the contents encryption key (common key Kc) (step S32), and a content ID is generated. Then, the contents encryption key and the access condition information are encrypted using a session key Ks, thereby generating a license (step S33). An example of access condition information is shown in FIG. 7C. An access condition information 70 shown in FIG. 7C can be a possible regeneration frequency 71, a possible transfer frequency 72, a possible regeneration tamper resistance level 73, a possible regeneration time 74, a regeneration term 75, etc. Any additional information 76 can be added. On the reception side, regeneration and a secondary transmission are performed based on the access condition.

Then, using the secret key in the public key encryption system (that is, the secret key Kx), a signature is generated, and added to the encrypted contents (step S34). Then, the content ID and its own (file exchange apparatus 40) URL are entered in the introduction service server 20 (step S35).

Then, the signed encrypted contents generated in step S34 and the license generated in step S33 are stored in a transmit enabled area (step S36). A transmit enabled area is an area in which only the transmitter DRM 41 of the file exchange apparatus 40 can rewrite data.

If it is determined that there is no request to encrypt plaintext contents in the determining process in step S31, then the processes in steps S32 and S33 are not performed, and the processes in and after step S34 are performed.

On the other hand, if the contents are encrypted contents, etc. obtained by downloading from the contents distribution provider or another file exchange apparatus (that is, if a secondary transmission is performed on the contents), then it is determined in the determining process in step S31 that the contents are encrypted contents. In this case, it is first determined whether or not there is a signature placed on the encrypted contents. If there is no signature (NO in step in S37), then control is passed to step S34 and a signature is forcibly generated and added. However, although not shown in the attached drawings, a user is allowed to select and input whether or not enabling for transmission is performed with a message that there is the possibility of the above-mentioned copyright protection violation displayed. If the user stops transmitting the encrypted contents, the process terminates. The case in which there are encrypted contents without a signature refers to a case in which encrypted contents without a signature are externally transmitted (in the process according to the present embodiment, the encrypted contents remain without deletion), a case in which a user intentionally deletes a signature, etc. Thus, a malicious user can be suppressed from an illegal secondary transmission while preventing an honest user from mistakenly committing a copyright protection violation. If no signature is placed, a secondary transmission request can be rejected.

After the process in step S34, the processes in steps S35 and S36 are performed, and the encrypted contents are set in a transmit enabled state, thereby terminating the process.

On the other hand, when a signature is placed on the encrypted contents (YES in step S37), the processes in and after step S38 are performed on the certificate and the license received with the encrypted contents.

First, the certificate attached to the encrypted contents is checked (step S38). If it is not determined as a check result that the certificate is correct because it is invalid or due to an error, etc. (NO in step S39), the transmit enable request for the encrypted contents is rejected, and the rejection message is displayed (step S42).

If the correctness of the certificate is confirmed as a check result (YES in step S39), then the signature of the encrypted contents is checked (step S40). If the correctness is confirmed (YES in step S41), then the encrypted contents and the license are recorded in the transmit enabled area (step S36).

Then, the contents transmitting process is described below by referring to FIG. 5.

Upon receipt of a request to transmit contents from any receiver, it is determined whether or not the requested contents are recorded in the transmit enabled area (step S51). If it is not recorded (NO in step S51), no transmission is performed, and a request rejection message is returned to the receiver (step S52).

On the other hand, if the requested contents are recorded in the transmit enabled area (YES in step S51), then the destination (that is, the receiver who has issued the request) DRM is authenticated (step S53). If the authentication is normally completed, then the license of the requested contents, the signed encrypted contents, and the certificate are transmitted to the destination DRM (steps S54 and S55).

Thus, the contents not recorded in the transmit enabled area, that is, the transmission of the contents not handled in the processes in steps S34 and S35 shown in FIG. 5 (signing using a secret key Kx, and an entry in an introduction service server) is forcibly rejected.

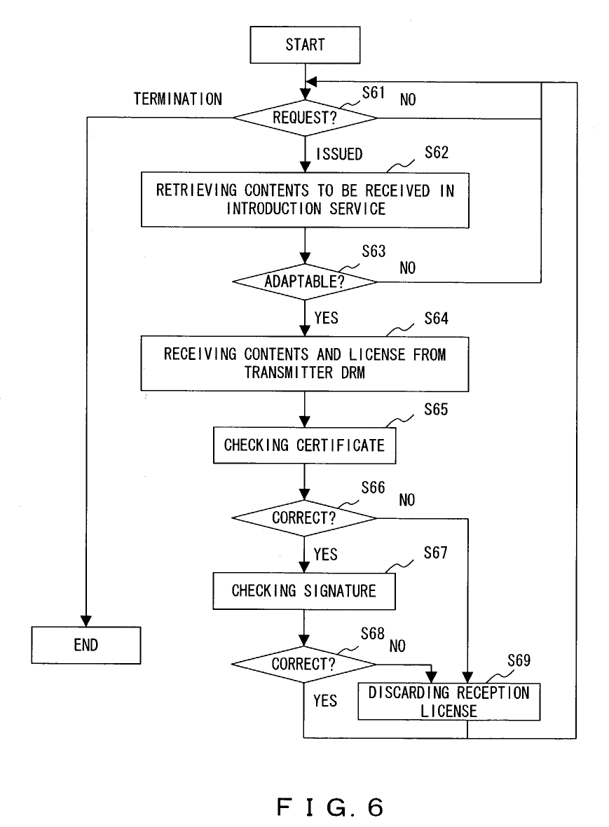

The process procedure of the receiver file exchange apparatus 30 (DRM 31) of contents receiver is explained below by referring to FIG. 6.

In FIG. 6, if a user inputs a request to obtain contents, etc. at any time (request is detected in step S61), then the DRM of the contents receiver first accesses the contents/license distribution server introduction unit 23 of the introduction service server 20. The contents/license distribution server introduction unit 23 prompts the user to input a desired retrieval condition (step S62). If contents in accordance with the retrieval condition have been entered (YES in step S63), then the content ID of the contents, the URL, etc. of the device in which the contents are placed are obtained, and the processes (9) and (10) shown in FIG.2 are performed.

That is, the device of the obtained URL is accessed, the contents of the obtained content ID are requested, and the encrypted contents, the license, and the certificate transmitted in response to the request are received (step S64).

Then, if the received certificate is checked (step S65), and the correctness can be confirmed (YES in step S66), then the signature is checked (step S67). If the correctness is confirmed (YES in step S68), then the contents can be regenerated by the receiver as described above. On the other hand, if the certificate is invalid or in error (NO in step S66), or if the correctness is not confirmed (NO in step S68), then the contents are forcibly unavailable. For example, the received license is discarded (step S69). It is obvious that any other appropriate methods can be used.

The license information is stored and managed in each DRM, but is encrypted for storage so that illegal movement or regeneration can be admitted.

By the transmission control capability of the above-mentioned file exchange apparatus (its DRM), the following effect can be obtained.

First, since the transmitter DRM can transmit only signed contents, an offender can be easily detected relating to the contents exchanged at least in the security domain of the secure P to P although contents without a due right are distributed. The contents once represented by analog data and then copied as digital data can be easily located through the secure P to P. Therefore, a motive to transmit contents without a due right can be effectively suppressed.

For an honest transmitter DRM user, a signature guarantees the originality of the contents, and it is assumed that a signature is welcomed by a request to assert the user's own copyright.

Also for a receiver DRM user, guaranteeing the originality of the contents used by regenerating and using by the user is beneficial because the contents passing through a super-distribution which are unknown about their distribution routes and the possibility of falsification can be relied upon.

Especially in Japan, using an illegal file exchange application can be detected without fail. Therefore, an illegal file exchange of valuable contents such as hits can be effectively suppressed.

Furthermore, since a major contents holder does not trust the current file exchange application, the distribution to a file exchange application is restricted. However, the file exchange apparatus according to the present invention can guarantee the reliability by adding the above-mentioned forcible transmission control capability to the function of the UDAC-MB evaluated for its contents protection (for example, “music with mobile phone”, etc.), thereby prospectively promoting the distribution to the file exchange application by major holders.

In the U.S., with a decreasing use of file exchange applications as a result of filtering hits as described above, it is predicted that a file exchange application capable of handling hits is expected. Other countries have their own but similar situations.

Additionally, as described above, the user can positively use the file exchange apparatus according to the present invention with the possibility of copyright protection violation suppressed, thereby inviting the following advantages.

Possibly receiving the distribution of valuable contents such as hits, etc. as is.

Realizing a file exchange application capable of performing super-distribution

That is, by implementing the file exchange apparatus (file exchange application) according to the present invention, it is predicted that there are an increasing number of contents exchanges among users. With the propagation of the file exchange application, a contents holder can safely and positively participate in the distribution of contents to the file exchange apparatus having a large number of active users. Thus, if hits, movies, program software are listed, the users can continuously purchase the contents from the convenient group of contents.

To promote the above-mentioned effects, for example, the Win-Win business model can be established in the following procedure.

(1) The file exchange application according to the present invention can be put into the market in the following five simultaneous activities.

Major contents distribution service

A file exchange application of a reception/regeneration only capability is distributed free of charge, or sold at a low price (for example, distributed at a copy license fee).

The high-level contents protection of the receiver file exchange application is advertised, and the transmitting capability entry member is invited.

Applications are propagated by supporting the contents distribution services for both members and receivers.

Personalization service for members.

(2) The number of major contents holders is to be increased by advertising the safety and the propagation of the receiver application.

(3) The number of receivers is to be increased by distributing valuable contents at a low price by an advertising model.

(4) Automatic super-distribution system: A server for providing encrypted contents for the amusement of the receiver functions as a proxy (cash server) among file exchange application users.

(5) Through the automatic super-distribution, the load for the number of distributions of contents distribution services can be reduced, and a major holder can distinguish the characteristics from those of other systems, thereby further promoting the participation, and increasing the volume of sales in the system and also increasing the amount of transaction fee.

Furthermore, the effects of the file exchange apparatus according to the present invention is not limited to those described above.

That is, the entry in the introduction service server 20 in steps S12 and S13 not only enables contents for transmission, but also allow the file exchange apparatus which can transmit contents to be equivalent to the conventional distribution server (contents distribution provider, etc.). That is, the user of the file exchange apparatus not only uses other users' contents, but also allows his or her originally generated contents to be introduced by the introduction service server 20 for sale.

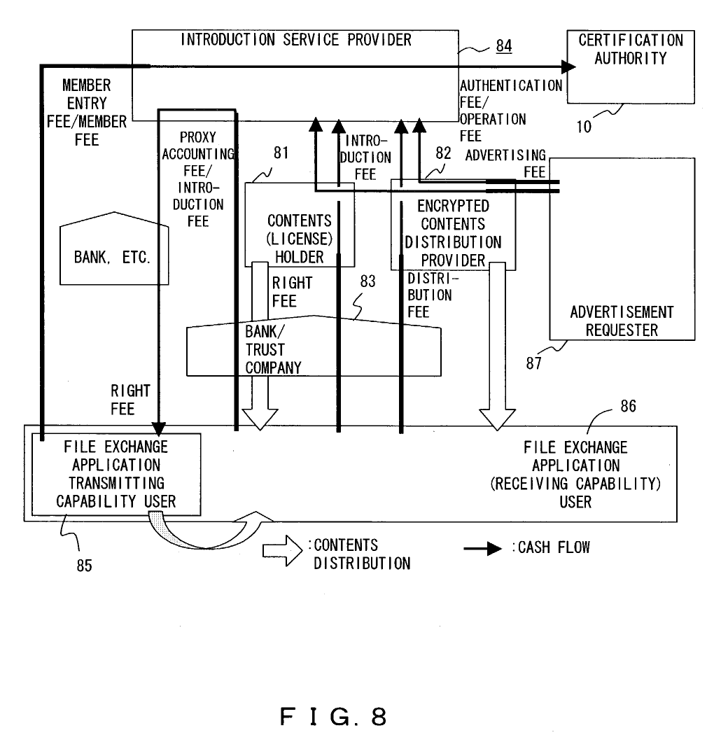

An example of the above-mentioned business model is explained below by referring to FIG. 8.

FIG. 8 shows the flow in the distribution of contents and the cash flow among the Certification Authority 10, a contents (license) holder 81, an encrypted contents distribution provider 82, a bank/trust company 83, an introduction service provider 84, a file exchange application transmitting capability user 85, a file exchange application receiving capability user 86, and an advertisement requester 87.

In FIG. 8, the flow of the distribution of contents and the cash flow among the contents (license) holder 81, the encrypted contents distribution provider 82, the bank/trust company 83, the introduction service provider 84, and the advertisement requester 87 have already been suggested in Japanese Patent Application No. H13-272638. That is, the contents (license) holder 81 and the encrypted contents distribution provider 82 pays the introduction service provider 84 the introduction fee for the introduction of the contents and a license to users. The introduction fee is paid from the advertising fee obtained from the advertisement requester 87 and the use fee (right fee, distribution fee, etc.) obtained from the user (in this example, a user of a file exchange application) who has downloaded contents/license from the encrypted contents distribution provider 82, etc.

Then, the file exchange application transmitting capability user 85 requests the introduction service server 20 to, for example, introduce and perform proxy-accounting on the contents originally generated by the user. That is, the introduction service provider 84 has the user make a member entry to use the transmitting capability of the file exchange apparatus of a member, and provides a personalization service for a transmitter member. In return, it receives a member entry fee and an annual fee. The introduction service provider 84 pays the Certification Authority 10 a part of the entry fee as a fee for issue of a certificate, and a part of the annual fee as fee for update of a certificate and operation.

After the member entry, the introduction service provider performs the introduction of the contents and proxy accounting for a transmitter member, and pays the transmitter member the right fee by subtracting the proxy-accounting fee and the introduction fee when the contents are purchased.

The necessary information about the payment of the member entry fee and the annual fee, the introduction of contents, the proxy accounting is included in the Sender entry request information transmitted in step S13 and the contents entry request information transmitted in step S35.

FIG. 7A shows an example of Sender entry request information. FIG. 7B shows an example of contents entry request information.

Sender entry request information 50 shown in FIG. 7A includes a request ID 51, a public key 52, a URL 53, the information about a user requesting an entry (for example, a name 54, an address 55, a credit card ID 56, a transfer account number 57, etc., and any personal information 58 can be added) The credit card ID 56 is used in paying a member entry fee and an annual fee. The transfer account number 57 is used in transferring the right fee for the sales of contents.

Contents entry request information 60 shown in FIG. 7B includes a request ID 61, a public key certificate 62, a URL 63, a content ID 64, a sales price 65, merchandise advertisement information 66, etc. Any additional information 67 can be added.

The sales price 65 and the merchandise advertisement information 66 are used in introducing contents.

Although not shown in the attached drawings, the introduction service server (personal information entry server) 20 includes a database storing the received Sender entry request information 50, and contents entry request information 60, and performs the above-mentioned contents introduction service, the proxy accounting service describe later, etc.

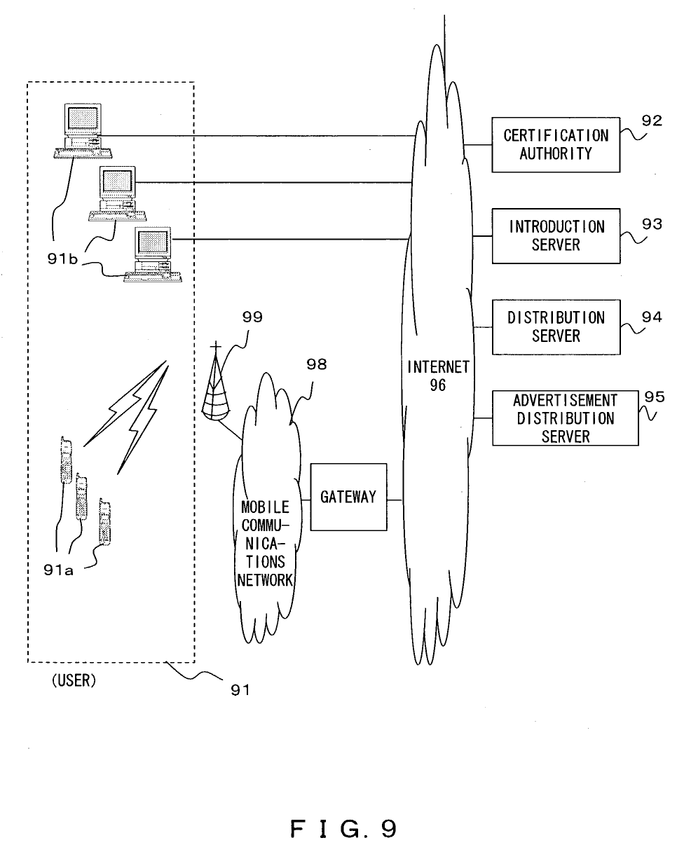

FIG. 9 shows the configuration of the network service corresponding to the business model shown in FIG. 8.

In FIG. 9, a user terminal 91 corresponds to the user terminal 1 shown in FIG. 1, and can be a mobile phone/PHS 91a loaded with the file exchange application according to the present embodiment or a personal computer 91b.

The mobile phone/PHS 91a is connected to the Internet 96 through a base station 99, a mobile communications network 98, and a gateway 97. The personal computer 91b, an Certification Authority server 92, a introduction server 93, a distribution server 94, and an advertisement distribution server 95 are also connected to the Internet 96 for mutual data communications.

The Certification Authority server 92 is a server for the Certification Authority 10. The introduction server 93 is operated by the introduction service provider 84, and can be, for example, the introduction service server 20. The introduction server 93 is operated by the contents (license) holder 81 or the encrypted contents distribution provider 82. The advertisement distribution server 95 is maintained by the advertisement requester 87.

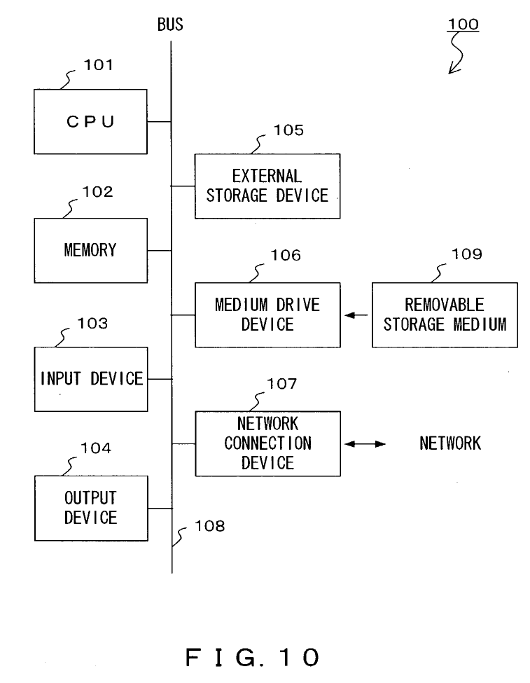

FIG. 10 shows an example of the hardware configuration of a (personal) computer or each of the above-mentioned servers (computers) which is an example of the user terminal.

Although not shown in the attached drawings, the mobile phone/PHS 91a which is an example of the user terminal can be configured by a CPU, a storage unit (memory, etc.), etc.

A computer 100 shown in FIG. 10 comprises a CPU 101, memory 102, an input device 103, an output device 104, an external storage device 105, a medium drive device 106, a network connection device 107, etc., and they are connected to a bus 108. The configuration shown in FIG. 10 is an example, and the appropriate configuration is not limited thereto.

The CPU 101 is a central processing unit for controlling the entire computer 100.

The memory 102 is can be RAM, etc. for temporarily storing a program or data stored in the external storage device 105 (or a removable storage medium 109) when the program is executed, the data is updated, etc. The CPU 101 performs the above-mentioned various processes using the program/data read to the memory 102

The input device 103 is, for example, a keyboard, a mouse, a touch panel, etc.

The output device 104 is, for example, a display, a printer, etc.

The input device 103 and the output device 104 can be omitted.

The external storage device 105 can be, for example, a hard disk device, etc., and stores a program/data, etc. for realization of the above-mentioned various functions.

The medium drive device 106 reads (or writes) a program/data, etc. recorded on the removable storage medium 109. The removable storage medium can be a removable storage medium having a storage capacity larger than a predetermined storage capacity such as an FD (flexible disk), CD-ROM, DVD, a magneto-optical disk, etc.

The network connection device 107 is connected to the network (Internet, etc.) to enable the communications of a program/data, etc. with an external information processing device.

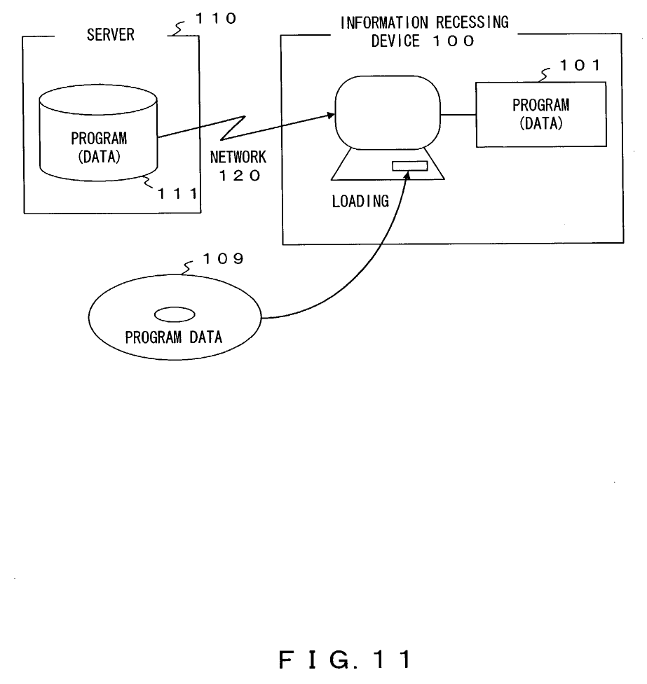

FIG. 11 shows an example of a storage medium recording the program, or downloading a program.

As shown in FIG. 11, the removable storage medium 109 storing the program/data for realizing the functions of the present invention can be inserted into the body of the computer 100 to read the program/data and stores and execute them, or the program/data can be obtained by downloading a program (data) 111 stored in a server 110 of an external program/data provider through a network 120 (Internet, etc.) connected through the network connection device 107.

Furthermore, the present invention is not limited to apparatuses/methods, and can be configured as a storage medium (removable storage medium 109, etc.) storing the above-mentioned program/data, and also can be configured as the program itself.

The explanation of the above-mentioned embodiments is only an example, and the present invention is not limited to them. For example, the number of processes can be smaller (the processing time can be shorter) by a method of confirming a signature placed on a license than by a method of confirming a signature placed on encrypted contents in the above-mentioned example.

Additionally, by the introduction service server 20 performing an accounting when a license is moved, a second-hand license rental service can be provided. At this time, in preparation for the case in which a contents holder requests to restrict the second hand rental service, a forcible movement control capability can be provided depending on the access condition designation and the designation conditions.

Furthermore, in the license transmitting process, not only the above-mentioned UDAC-MB, but also the UDAC-PI (protocol independent) suggested by the present applicant in Japanese Patent Application No. 2001-246398 “Transmission Distribution system in Offline Environment of License” can be used.

As described above, the file exchange apparatus, the personal information entry/introduction server, and the program according to the present invention avoid as much as possible the possibility that a user of a file exchange application can commit a copyright protection violation, and suppress illegal remote copying of contents, thereby promoting the distribution to a file exchange application by a contents holder, etc., and supporting the distribution and sales of contents of the users themselves.

What is claimed is:

1. A file exchange apparatus of a user terminal which provides a file exchanging capability among user terminals, comprising
a transmission control unit encrypting a plaintext file, generating a license, placing a digital signature on the encrypted file or the license using a secret key, adding a digital signature to the file or the license using the secret key when no digital signature is detected, and storing the file or the license in a transmit enabled area.

2. The apparatus according to claim 1, wherein
when no signature is detected on the encrypted file when a secondary transmission is performed, said transmission control unit either disables the secondary transmission or displays a warning and adds a signature of a user who attempts the secondary transmission.

3. The apparatus according to claim 1, further comprising
a reception control unit controls contents of a received file to be unavailable when no signature is detected on the received file, or when it is determined whether or not a signature of a received signed file is correct and that the signature is not correct.

4. The apparatus according to claim 3, further comprising
an entry unit transmitting personal information about a user of the file exchange apparatus, and an entry request including a public key in a public key encryption system to an external personal information entry server, and, in response to the entry request, receiving a certificate issued by a Certification Authority through the personal information entry server, wherein
said transmission control unit is available when said entry unit makes an entry.

5. The apparatus according to claim 4, wherein:
when a file transmission request is issued by a file exchange apparatus of a receiver, said transmission control unit transmits the signed encrypted file or license with the certificate to the file exchange apparatus of the receiver; and
when a received certificate becomes invalid, said reception control unit of the file exchange apparatus of the receiver controls contents of the received file to be unavailable.

6. The apparatus according to claim 3, wherein
said transmission control unit or reception control unit is configured as a tamper resistant module, and the tamper resistant module has DRM (digital right management); and
the transmit enabled area can be rewritten only by the DRM.

7. The apparatus according to claim 4, wherein:
said transmission control unit generates a content ID corresponding to an encrypted file obtained by encrypting the plaintext file, and enters the content ID together with an address of the user terminal in the personal information entry server; and
the personal information entry server is allowed to provide a service of introducing contents of a transmitting capability user of the file exchange apparatus.

8. The apparatus according to claim 4, wherein
said reception control unit accesses the personal information entry server, selects any contents from among contents of transmitting capability users of the file exchange apparatus entered in the personal information entry server, obtains the content ID of the selected contents and an address of a user terminal, and transmits a file transmission request of contents corresponding to the content ID to the user terminal of the obtained address.

9. The apparatus according to claim 1, wherein
said transmission control unit performs DRM authentication when the license is transferred.

10. The apparatus according to claim 1, wherein
the plaintext file is encrypted using a common key, and the license is generated by encrypting the common key using a secret key commonly used with the file exchange apparatus of the receiver or a public key of the file exchange apparatus of the receiver.

11. The apparatus according to claim 10, wherein
the license is generated by being encrypted after information designating a retransmission condition of the receiver is coupled to the common key.

12. A file exchange apparatus in a user terminal which provides a file exchanging capability among user terminals, comprising
a reception control unit controlling contents of a received file to be unavailable when no signature is detected on the received file, or when it is checked whether or not a signature of a received signed file is correct and determined that the signature is not correct.

13. A personal information entry/introduction server which communicates with the file exchange apparatus, comprising
a personalization unit entering personal information each time an entry request including user personal information and a public key is transmitted from each file exchange apparatus, requesting an Certification Authority to issue a certificate corresponding to the public key, and transferring an issued certificate to the file exchange apparatus.

14. The server according to claim 13, further comprising
a user contents introduction unit entering a contents file each time the file exchange apparatus of the entered user issues an entry request for any contents file, and introducing the entered contents file to any file exchange apparatus.

15. The server according to claim 14, wherein
when contents of the entered user are sold to a user of any file exchange apparatus, a proxy accounting operation is performed.

16. A transmission controlling method for use with a file exchange apparatus of a user terminal which provides a file exchanging capability among user terminals, comprising
encrypting a plaintext file, generating a license, placing a digital signature on the encrypted file or the license using a secret key, adding a digital signature to the file or the license using the secret key when no digital signature is detected, and storing the file or the license in a transmit enabled area.

17. The method according to claim 16, wherein
when no signature is detected on the encrypted file when a secondary transmission is performed, the secondary transmission is disabled, or a warning is displayed and a signature of a user who attempts the secondary transmission is added.

18. The method according to claim 16, wherein
personal information about a user of the file exchange apparatus, and an entry request including a public key in a public key encryption system are transmitted to an external personal information entry server, in response to the entry request, a certificate issued by an Certification Authority through the personal information entry server is received, and the encrypted file is transmitted together with the signature and the certificate.

19. A file exchanging method, wherein
a file exchange apparatus of a user requesting contents to be enabled for transmission transmits an entry request of a DRM of the apparatus to an introduction server including a public key of a pair of a public key and a secret key secretly generated in the DRM and personal information about the user;
the introduction server checks whether or not the entry request information is deficient, if the information is not deficient, enters the personal information, transmits the public key to an Certification Authority, has a corresponding certificate issued, and transmits the certificate to the DRM as a result of entry completion;
after receiving the certificate, the DRM encrypts the plaintext contents using a common key secretly generated in the DRM, generates a digital signature of the encrypted contents using the generated secret key, adds the digital signature to the encrypted contents, and enters a content ID corresponding to the encrypted contents and an address of the DRM in the introduction server;
the file exchange apparatus of the receiver browses the menu of the introduction server, retrieves encrypted contents of the transmitter, and selects the contents if the contents are to be obtained, browsed, or purchased;
the introduction server transmits the content ID of the selected contents and an address of the receiver to the file exchange apparatus of the receiver;
the file exchange apparatus of the receiver requests contents of the obtained content ID based on the address obtained from the introduction server, performs DRM authentication, and obtains a license and/or signed encrypted contents from the file exchange apparatus of the transmitter; and
the file exchange apparatus of the receiver checks the signature of obtained encrypted contents, and if the signature is correct, the apparatus records the signature.

20. A reception control method, wherein
when no signature is detected on the received file, or when it is determined whether or not a signature of a received signed file is correct and that the signature is not correct, or when a certificate attached to the signed file is invalid, contents of the received file is controlled to be unavailable.

21. A computer-readable storage medium storing a program for directing a computer having a file exchanging capability among users to perform the functions of:
encrypting a plaintext file, generating a license, placing a digital signature on the encrypted file or the license using a secret key, adding a digital signature to the file or the license using the secret key when no digital signature is detected, and storing the file or the license in a transmit enabled are.

22. The computer-readable storage medium according to claim 21, further comprising the functions of:
when no signature is detected on the encrypted file when a secondary transmission is performed, disabling the secondary transmission, or displaying a warning and adding a signature of a user who attempts the secondary transmission.

23. The computer-readable storage medium according to claim 21, further comprising the functions of:
transmitting personal information about a user, and an entry request including a public key in a public key encryption system to an external personal information entry server, and in response to the entry request, receiving a certificate issued by an Certification Authority through the specific server; and
rejecting transmission or a transmit enable request until the certificate is received.

24. A computer-readable storage medium storing a program for directing a computer having a file exchanging capability among users to realize the functions of:
controlling contents of the received file to be unavailable when no signature is detected on the received file, or when it is determined whether or not a signature of a received signed file is correct and that the signature is not correct, or when a certificate attached to the signed file is invalid.
